(19) United States
(12) Patent Application Publication
(10) Pub. No.: US 2014/0007599 A1
(43) Pub. Date: Jan. 9, 2014

(54) HEAT PUMP SYSTEM FOR A LAUNDRY DRYER AND A METHOD FOR OPERATING A HEAT PUMP SYSTEM OF A LAUNDRY DRYER

(71) Applicant: Francesco Cavarretta, Pordenone (IT)

(72) Inventor: Francesco Cavarretta, Pordenone (IT)

(73) Assignee: ELECTROLUX HOME PRODUCTS CORPORATION N.V., Brussels (BE)

(21) Appl. No.: 13/997,898

(22) PCT Filed: Dec. 21, 2011
(86) PCT No.: PCT/EP2011/073614

§ 371 Date: Sep. 24, 2013

(30) Foreign Application Priority Data
Dec. 27, 2010 (EP) 10197044.0

(51) Int. Cl. F26B 23/00

(52) U.S. Cl. CPC F26B 23/001
USPC 62/79; 62/238.7

(57) ABSTRACT

A laundry dryer with a heat pump system is provided. The heat pump system includes a refrigerant circuit and a closed air stream circuit. The refrigerant circuit and the air stream circuit are thermally coupled by an evaporator and a condenser. The condenser is provided for heating up the air stream and cooling down the refrigerant. The evaporator is provided for cooling down the air stream and heating up the refrigerant. The refrigerant circuit includes at least one heat exchanger with a low pressure side and a high pressure side. The low pressure side and the high pressure side are thermally coupled. The low pressure side connects an outlet of the evaporator to an inlet of the compressor. The high pressure side is a part of a branch circuit portion arranged parallel to the condenser. A corresponding method for operating a heat pump laundry dryer is also provided.

The present invention relates to a heat pump laundry dryer according to the preamble of claim 1. Additionally, the present invention relates to a method for operating a heat pump laundry dryer for a tumble dryer according to the preamble of claim 11.

The heat pump technology is the most efficient way to save energy in a laundry dryer during drying laundry. However, in heat pump systems used in laundry drying systems there are some intrinsic issues related to the proper behaviour of the heat pump system. Further, there are intrinsic issues related to the interaction between the heat pump system itself and the closed air stream circuit in the laundry dryer.

One issue relates to the long warm-up time of the heat pump system in laundry dryer. When the heat pump system starts, all the components are at the temperature of the ambient. Unlike conventional electric laundry dryers which supply the heating power immediately to the air stream circuit, the power in heat pump systems must be recovered by a dehumidification of the air itself. At the beginning the dehumidifying power is very low, so that only a little water is extracted from the laundry. Then the dehumidifying power increases as the heat pump cycle goes on. Thus, it takes time for the whole heat pump system to get into its full power steady state working phase.

Another issue results in the intrinsic unbalance between the refrigerant circuit and the air stream circuit, after the steady state working phase has been reached. In said steady state working phase the air stream flowing in the air stream circuit exchanges the same power to be heated and dehumidified. This is badly matched with the proper characteristics of the heat pump system, in which the heating power of the condenser, where the air stream is heated, is necessarily higher than the cooling power of the evaporator, where the air stream is dehumidified. Said proper characteristics of the heat pump system result from the relationship, that the cooling power and the compressor power correspond with the power of the condenser.

The heat pump system is unbalanced, because the same air stream is cooled in the evaporator and then heated in the condenser, wherein more heating capacity is available on the refrigerant side of the condenser. This results in a continuous increasing of the temperature in the heat pump system and an increasing of the pressure of the refrigerant. This behaviour is advantageous during the warm-up phase, but disadvantageous during the steady state working phase.

It is an object of the present invention to provide laundry dryer with a heat pump system, which overcomes the above mentioned problems. Further, it is an object of the present invention to provide a method for operating a laundry dryer with a heat pump system, which overcomes the problems due to unbalancing behaviour of heat pump laundry dryer.

The object of the present invention is achieved by the heat pump laundry dryer according to claim 1.

According to the present invention the refrigerant circuit includes at least one internal heat exchanger with a low pressure side and a high pressure side, the low pressure side and the high pressure side are thermally coupled, the low pressure side connects an outlet of the evaporator to an inlet of the compressor, and the high pressure side is a part of a branch circuit portion arranged parallel to the condenser.

The present invention includes the branch circuit portion and the internal heat exchanger. Part of the refrigerant flows through the condenser whereas another part of the refrigerant can flow through the branch circuit portion provided with the high pressure side of the internal heat exchanger. This arrangement allows that the unbalance between the refrigerant circuit and the air stream circuit can be removed or drastically reduced.

According to a preferred embodiment, the branch circuit portion extends between the compressor and a refrigerant mixing section provided upstream of the expansions means.

According to a further preferred embodiment, the branch circuit portion extends between the compressor and a refrigerant mixing section provided downstream of the expansions means.

According to another further preferred embodiment, the branch circuit portion includes expansion means arranged upstream of a refrigerant mixing section.

The refrigerant mixing section is defined as the section wherein the part of the refrigerant coming from the condenser and the part of the refrigerant coming from the high pressure side of the internal heat exchanger mix together before passing the evaporator.

According to a preferred embodiment of the present invention the branch circuit portion includes an auxiliary condenser arranged downstream of the high pressure side of the internal heat exchanger. The auxiliary condenser allows a further or complete condensation of the refrigerant.

Preferably, the auxiliary condenser is arranged outside the air stream circuit.

Preferably, the auxiliary condenser is a heat exchanger and provided for cooling down the refrigerant. In particular, an auxiliary fan is provided to direct air towards the auxiliary condenser.

Preferably, the auxiliary fan can be activated, when the on-off valve is opened or when the steady state working phase of the heat pump system starts, respectively.

Preferably, the auxiliary fan is kept activated, when the temperature of the refrigerant at an outlet of the auxiliary condenser is above a predetermined threshold value, which corresponds with the refrigerant completely condensed.

Preferably, a parameter for controlling the auxiliary fan can be the difference between the temperatures at the outlets of the condenser and the auxiliary condenser, and preferably, the auxiliary fan is activated or deactivated in order to keep said difference within a predetermined range.

Further, the branch circuit portion includes a control valve for opening and closing said branch circuit portion. If the control valve closes the branch circuit portion, then the refrigerant circuit acts as a conventional heat pump system.

For example, the control valve is arranged between the compressor and the high pressure side of the internal heat exchanger.

In an alternative embodiment, the control valve can be arranged downstream of the high pressure side of the internal heat exchanger.

Further the control valve can be arranged downstream of the auxiliary condenser.

The control valve may be an on-off valve and/or an adjustable control valve.

Additionally, the branch circuit portion may include a one-way valve arranged upstream of the refrigerant mixing section. The one-way valve avoids that condensed refrigerant flows into the auxiliary condenser instead of the expansion means.

Moreover, the air stream circuit includes at least one main fan for driving the air stream.

Further, the present invention relates to a laundry dryer with at least one heat pump system, wherein the laundry dryer comprises at least one of the above mentioned heat pump systems.

The object of the present invention is further achieved by the method for operating the laundry dryer with a heat pump system according to claim 11.

According to the present invention the method comprises the further steps of:
feeding a primary part of the refrigerant coming from the compressor to the condenser,
branching off a secondary part of the refrigerant coming from the compressor to a branch circuit portion,
condensing and cooling down the primary part of the refrigerant by the condenser,
cooling down the secondary part of the refrigerant by an internal heat exchanger, wherein the refrigerant between an outlet of the evaporator and an inlet of the compressor is heated up,
mixing the primary part and secondary part of the refrigerant before feeding the mixed refrigerant to the evaporator.

The present invention includes that one part of the refrigerant flows through the condenser and another part of the refrigerant flows through the branch circuit portion with the high pressure side of the internal heat exchanger, wherein the refrigerant flowing through the high pressure side of the internal heat exchanger is condensed completely or partially, whereas the refrigerant flowing through the low pressure side of the internal heat exchanger is vaporized before the refrigerant enters the compressor. This method allows that the unbalance between the refrigerant circuit and the air stream circuit can be removed or drastically reduced.

According to a preferred embodiment, the mixing of the primary part and secondary part of the refrigerant occurs before feeding the mixed refrigerant to the expansion means.

According to a further preferred embodiment, the mixing of the primary part and secondary part of the refrigerant occurs after expanding the primary part and secondary part of the refrigerant.

Preferably, the feeding of a secondary part of the refrigerant through a branch circuit portion occurs during a steady working phase of the heat pump system.

According to a preferred embodiment of the present invention the secondary part of the refrigerant is cooled down and condensed by an auxiliary condenser in the branch circuit portion.

Preferably, the method includes the step of cooling down of the auxiliary condenser by an auxiliary fan, which can be activated, when the steady state working phase of the heat pump system starts.

Preferably, the method includes the step of cooling down of the auxiliary condenser by an auxiliary fan, which is kept activated, when the temperature of the refrigerant at an outlet of the auxiliary condenser is above a predetermined threshold value.

In another embodiment, a parameter for controlling the auxiliary fan may be the difference between the temperatures at the outlets of the condenser and the auxiliary condenser. In this case, the auxiliary fan 30 is activated or deactivated in order to keep said difference within a predetermined range.

Preferably, the auxiliary condenser is arranged outside the air stream circuit.

Further, the branch circuit portion may be controlled by an on-off valve or by an adjustable control valve.

For example, the branch circuit portion is controlled by a one-way valve arranged upstream of an inlet of the expansion means.

At last, the method may be performed by laundry dyer with a heat pump system as mentioned above.

It is to be noted that the present invention is applicable to heat pump circuit wherein the pressure of the refrigerant is above the critical pressure at the high pressure side of the heat pump circuit. For example in CO₂ transcritical system, the Carbon Dioxide refrigerant is always in gaseous phase (of course when the heat pump system is in steady working condition) between the compressor outlet and expansion means inlet (i.e. the high pressure side of the heat pump circuit). Therefore in trans-critical system there is no refrigerant condensation in the heat pump condenser which acts simply as a gas cooler.

It follows that in the present invention heat pump condenser it to be interpreted as heat pump gas cooler in case of trans-critical system.

The novel and inventive features believed to be the characteristic of the present invention are set forth in the appended claims.

The invention will be described in further detail with reference to the drawings, in which

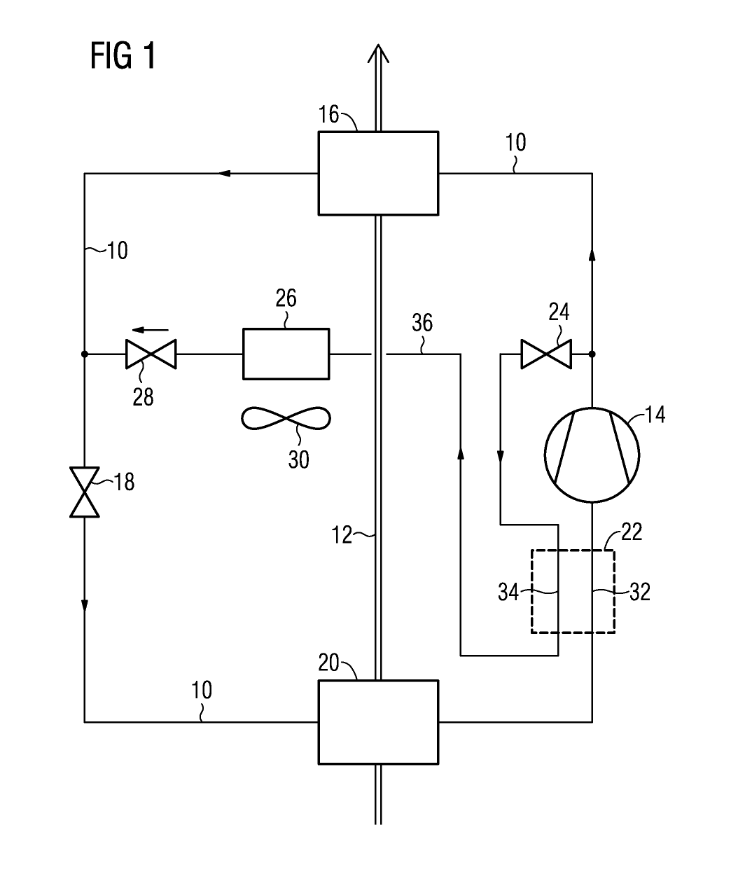

FIG. 1 illustrates a schematic diagram of a heat pump system for a tumble dryer according to a preferred embodiment of the present invention.

FIG. 1 illustrates a schematic diagram of a heat pump system for a laundry dryer, preferably a tumble dryer having a rotatable drum, according to a preferred embodiment of the present invention. The heat pump system includes a refrigerant circuit 10 and an air stream circuit 12, preferably closed. In FIG. 1 the refrigerant circuit 10 is completely shown. However, only some components of the air stream circuit 12 are illustrated in FIG. 1.

The refrigerant circuit 10 includes a compressor 14, a condenser 16, expansion means 18, an evaporator 20 and an internal heat exchanger 22. The internal heat exchanger 22 comprises a low pressure side 32 and a high pressure side 34. The compressor 14, the condenser 16, the expansion means 18, the evaporator 20 and the low pressure side 32 of the internal heat exchanger 22 are switched in series and form a main loop of the refrigerant circuit 10.

Further, the refrigerant circuit 10 includes an on-off valve 24, and, preferably, an auxiliary condenser 26 and, preferably, a one-way valve 28. An auxiliary fan 30 corresponds with the auxiliary condenser 26 for cooling down the latter. The on-off valve 24, the high pressure side 34 of the internal heat exchanger 22 are switched in series and form a branch circuit portion 36 within the refrigerant circuit 10. The branch circuit portion 36 can includes the auxiliary condenser 26 and/or the one-way valve 28. Said branch circuit portion 36 extends from an outlet of the compressor 14 to an inlet of the expansion means 18, as shown in FIG. 1. The refrigerant mixing section, wherein the part of the refrigerant coming from the condenser and the part of the refrigerant coming from the high pressure side of the internal heat exchanger mix together, is provided upstream of the expansion means 18.

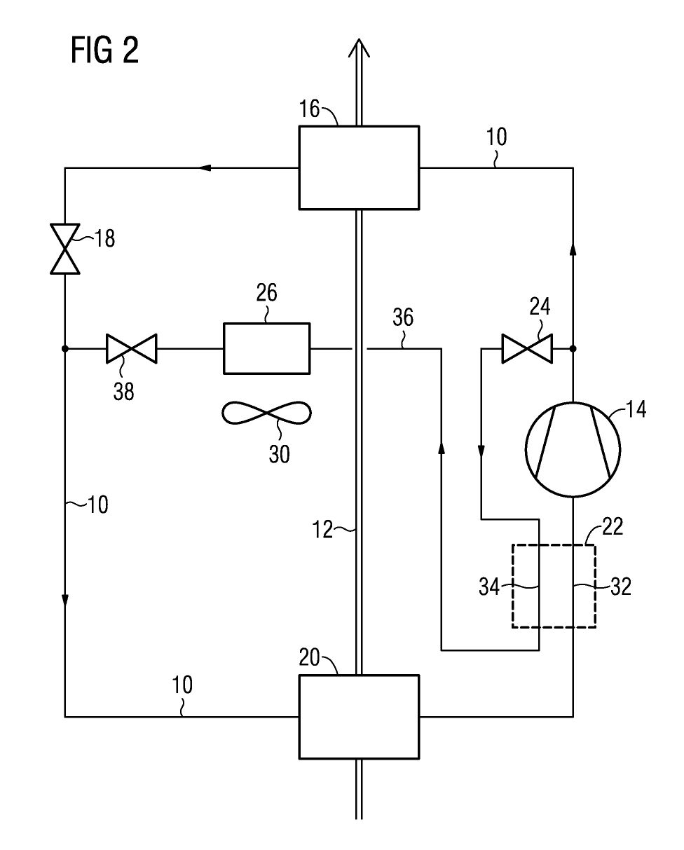

Alternatively, as shown in FIG. 2, the branch circuit portion 36 extends from an outlet of the compressor 14 to the inlet of the evaporator 20. The refrigerant mixing section, wherein the part of the refrigerant coming from the condenser and the part of the refrigerant coming from the high pressure side of the internal heat exchanger mix together, is provided downstream of the expansion means 18 and, preferably, the branch circuit portion 36 includes additionally expansions means 38.

The branch circuit portion 36 is switched in parallel to the condenser 16.

The main loop of the refrigerant circuit 10 is subdivided into a high pressure portion and a low pressure portion. The high pressure portion extends from the compressor 14 via the condenser 16 to the expansion means 18. The low pressure portion extends from the expansion means 18 via the evaporator 20 and the low pressure side 32 of the internal heat exchanger 22 to the compressor 14. In the embodiment shown in FIG. 1, the branch circuit portion 36 is arranged within the high pressure portion of the refrigerant circuit 10, whereas in the embodiment shown in FIG. 2, the branch circuit portion 36 is arranged partially within the high pressure portion of the refrigerant circuit 10 since the branch circuit portion 36 includes the additionally expansion means 38.

The internal heat exchanger 22 is arranged between the high pressure portion and the low pressure portion of the refrigerant circuit 10. The high pressure side 34 of the internal heat exchanger 22 is a part of the branch circuit portion 36. The low pressure side 32 of the internal heat exchanger 22 is a part of the main loop of the refrigerant circuit 10, i.e. at the low pressure portion of said main loop.

The condenser 16, the evaporator 20 are heat exchangers and form the thermal interconnections between the refrigerant circuit 10 and the air stream circuit 12. The air stream circuit 10 includes the evaporator 20, and the condenser 16 as shown in FIG. 1. Further, the air stream circuit 10 includes a laundry drum and a main fan, which are not shown in FIG. 1.

In the air stream circuit 12 the evaporator 20 cools down and dehumidifies the air stream, after the air stream has passed the laundry drum. Then the condenser 16 heats up the air stream, before the air stream is re-inserted into the laundry drum. The air stream is driven by the main fan.

In the main loop of the refrigerant circuit 12 a refrigerant is compressed by the compressor 14, condensed in the condenser 16, laminated in the expansion means 18, vaporised in the evaporator 20 and in the low pressure side 32 of the internal heat exchanger 22.

The branch circuit portion 36 of the refrigerant circuit is opened and closed by the on-off valve 24. The on-off valve 24 acts as a control valve. The branch circuit portion 36 is, preferably, closed during a warm-up phase of the heat pump system for speeding up the reaching of steady state working phase of the heat pump system.

The branch circuit portion 36 is, preferably, opened during a steady state working phase of the heat pump system.

In the warm-up phase of the heat pump system, when the on-off valve 24 and the branch circuit portion 36 are closed, the heat pump system works as a conventional heat pump system with one closed loop. The open branch circuit portion 36 allows different flow rates of the refrigerant in the condenser 16 and in the evaporator 20.

In the branch circuit portion 36 the compressed refrigerant coming from the compressor 14 and passing the on-off valve 24 is condensed, totally or partially, in the high pressure side 34 of the internal heat exchanger 22. In the auxiliary condenser 26, when envisaged, the refrigerant is completely condensed and passes the one-way valve 28. The refrigerant coming from the condenser 16 and that refrigerant coming from the one-way valve 28 (and from the auxiliary condenser 26, if envisaged) are mixed and laminated by the expansion means 18, as can be seen in the embodiment depicted in FIG. 1. Then the refrigerant passes the evaporator 20 and the low pressure side 32 of the internal heat exchanger 22.

Alternatively, as shown in FIG. 2 embodiment, in the branch circuit portion 36 the compressed refrigerant coming from the compressor 14 and passing the on-off valve 24 is condensed, totally or partially, in the high pressure side 34 of the internal heat exchanger 22. In the auxiliary condenser 26, when envisaged, the refrigerant is completely condensed and passes the additional expansion means 38. The refrigerant coming from the expansion means 18 and that refrigerant coming from the additional expansion means 38 are mixed upstream the inlet of the evaporator 20. Then the refrigerant passes the evaporator 20 and the low pressure side 32 of the internal heat exchanger 22.

When the on-off valve 24 and the branch circuit portion 36 are open, the evaporator 20 can be kept flooded during the steady state working phase of the heat pump system, i.e. a liquid/vapour bi-phase mixture is present at the outlet of the evaporator, thereby increasing the cooling capacity of the evaporator. The vaporization of the refrigerant, before entering the compressor 14, is completed in the low pressure side 32 of the internal heat exchanger 22, wherein the refrigerant is also superheated.

The amount of refrigerant flowing through the condenser 16 is smaller than the amount of refrigerant flowing through the evaporator 20, in this way the air stream receives by the condenser 16 a suitable amount of heat and the heat pump system is balanced.

The remaining part of the refrigerant coming from the compressor 14 is condensed, totally or partially, in the high pressure side 34 of the internal heat exchanger 22, wherein heat is released to the refrigerant coming from the evaporator 20 via the low pressure side 32 of the internal heat exchanger 22.

Since the internal heat exchanger 22 is arranged between the branch circuit portion 36 and the low pressure portion of the main loop of the refrigerant circuit 10, the internal heat exchanger 22 does not act, if the on-off valve 24 and the branch circuit portion 36 are closed.

When the on-off valve 24 and the branch circuit portion 36 are open, then the refrigerant coming from the compressor 14 and entering the branch circuit portion 36 is condensed in the high pressure side 34 of the internal heat exchanger 22. The auxiliary condenser 26 can complete the condensation of the refrigerant. In the embodiment of FIG. 1, the refrigerants coming from the condenser 16 and the auxiliary condenser 26 are mixed before passing the expansion means 18 and the evaporator 20, whereas in the embodiment of FIG. 2, the refrigerants coming from the expansion means 18 and the additional expansion means 38 are mixed before passing the evaporator 20. In this way the unbalance between the refrigerant circuit 10 and the air stream circuit 12 is removed.

Another important advantage of the present invention is that the evaporator 20 can be kept flooded transferring a superheating phase from said evaporator 20 to the low pressure side 32 of the internal heat exchanger 22. Superheating is defined as the difference between the fluid temperature at the outlet of the evaporator and the saturation temperature corresponding to the evaporation pressure. If the superheating is zero, then the temperature at the outlet of the evaporator 20 is exactly the temperature of saturation. If the superheating is more than zero, then the temperature at the outlet of the evaporator 20 is bigger than the temperature of saturation for the refrigerant.

A certain superheating of the refrigerant is advantageous for the lifetime of the heat pump system, because the compressor 14 cannot be fed up by liquid. Further, the certain superheating of the refrigerant is useful at the beginning of the drying cycle, because it speeds up in the warm-up phase. However, superheating penalizes the cooling capacity of the evaporator 20 and the efficiency due to the low vapour thermal capacity. Keeping the evaporator 20 flooded improves the performance of the heat pump system.

In this example, a part of the refrigerant is condensed in the high pressure side 34 of the internal heat exchanger 22, while the vaporization of the refrigerant coming from the evaporator 20 is completed at the low pressure side 32 of the internal heat exchanger 22, where preferably superheating of the refrigerant occurs.

The on-off valve 24 is provided for supplying a predetermined percentage of the flow rate to the branch circuit portion 36. Instead of the on-off valve 24 or additionally, an adjustable control valve may be provided improving the control of the heat pump system. When the on-off valve 24 is closed, then all refrigerant coming from the compressor 14 is forced to flow in the condenser 16.

The one-way valve 28 downstream of the auxiliary condenser 26 avoids that condensed refrigerant flows into said auxiliary condenser 26 instead of the expansion means 18.

When the desired temperatures of the air stream and the refrigerant have been reached, then the on-off valve 24 is opened and the heat pump system starts working with the branch circuit portion 36.

The on-off valve 24 remains closed during the warm-up phase and will be opened when the steady state working phase has been reached. The on-off valve 24 remains open until the end of the laundry drying cycle.

The steady state working phase starts, when the temperature of the air stream and/or the temperature and/or pressure of the refrigerant are detected to have predetermined values. Preferably, the temperature of the air stream is detected in the laundry drum. The temperature and/or pressure of the refrigerant may be previously detected at the outlet of the condenser 16.

An aspect of the present invention is the supply of the branch circuit portion 36 with a certain percentage of the flow rate of the refrigerant. The flow rate of the refrigerant is split up between the main circuit leading to the condenser 16 and the branch circuit portion 36 in such a manner that the condenser 16 releases the same power to the air stream as the evaporator 20 absorbs from the air stream. In this way, the balance of the heat pump system is accomplished.

The auxiliary condenser 26 is particularly required then, if the refrigerant is not completely condensed in the high pressure side 34 of the internal heat exchanger 22. Thus, it depends on the sizes of the heat pump system and the internal heat exchanger 22, whether the auxiliary condenser 26 is necessary.

If the heat pump system comprises the auxiliary condenser 26, then the auxiliary fan 30 can be activated, when the on-off valve 24 is opened or when the steady state working phase of the heat pump system starts, respectively. The auxiliary fan 30 may be activated without any interruption during the drying cycle.

Alternatively, the auxiliary fan 30 may be kept activated, when the temperature of the refrigerant at an outlet of the auxiliary condenser 26 is above a predetermined threshold value, which corresponds with the refrigerant completely condensed.

In another embodiment, a parameter for controlling the auxiliary fan 30 may be the difference between the temperatures at the outlets of the condenser 16 and the auxiliary condenser 26. In this case, the auxiliary fan 30 is activated or deactivated in order to keep said difference within a predetermined range.

Further, the auxiliary fan 30 may have a variable speed. Said variable speed may be proportional to the difference between the temperatures at the outlets of the condenser 16 and the auxiliary condenser 26.

Although an illustrative embodiment of the present invention has been described herein with reference to the accompanying drawings, it is to be understood that the present invention is not limited to that precise embodiment, and that various other changes and modifications may be affected therein by one skilled in the art without departing from the scope or spirit of the invention. All such changes and modifications are intended to be included within the scope of the invention as defined by the appended claims.

### LIST OF REFERENCE NUMERALS

10 refrigerant circuit
12 air stream circuit
14 compressor
16 condenser
18 expansion means
20 evaporator
22 internal heat exchanger
24 on-off valve
26 auxiliary condenser
28 one-way valve
30 auxiliary fan
32 low pressure side
34 high pressure side
36 branch circuit portion
38 additional expansion means

1. A laundry dryer with a heat pump system, wherein:
the heat pump system comprises a refrigerant circuit for a refrigerant and an air stream circuit for an air stream,
the refrigerant circuit includes a compressor, a condenser, expansion means and an evaporator,
the air stream circuit includes the evaporator, the condenser, a laundry chamber and at least one fan,
the refrigerant circuit and the air stream circuit are thermally coupled by the evaporator and the condenser,
the condenser is a heat exchanger and provided for heating up the air stream and cooling down the refrigerant,
the evaporator is a heat exchanger and provided for cooling down the air stream and heating up the refrigerant,
the refrigerant circuit includes at least one internal heat exchanger with a low pressure side and a high pressure side,
the low pressure side and the high pressure side are thermally coupled,
the low pressure side connects an outlet of the evaporator to an inlet of the compressor, and
the high pressure side is a part of a branch circuit portion arranged parallel to the condenser.

2. The laundry dryer according to claim 1, wherein
the branch circuit portion includes a control valve for opening and closing said branch circuit portion.

3. The laundry dryer according to claim 2, wherein
the control valve is arranged between the compressor and the high pressure side of the internal heat exchanger.

4. The laundry dryer according to claim 2, wherein
the control valve is an on-off valve.

5. The laundry dryer according to claim 1, wherein
the branch circuit portion extends between the compressor and a refrigerant mixing section provided upstream of the expansions means.

6. The laundry dryer according to claim 1, wherein
the branch circuit portion extends between the compressor and a refrigerant mixing section provided downstream of the expansions means.

7. The laundry dryer according to claim 1, wherein
the branch circuit portion includes additional expansion means arranged upstream of a refrigerant mixing section.

8. The laundry dryer according to claim 1, wherein
the branch circuit portion includes an auxiliary condenser arranged downstream of the high pressure side of the internal heat exchanger.

9. The laundry dryer according to claim 8, wherein
an auxiliary fan is provided for cooling down the auxiliary condenser, wherein the auxiliary fan is configured to be activated when the on-off valve is opened.

10. The laundry dryer according to claim 1, wherein
the branch circuit portion includes a one-way valve arranged upstream of a refrigerant mixing section.

11. A method for operating a laundry dryer with heat pump system comprising:
compressing and heating up a refrigerant in a closed refrigerant circuit by a compressor,
cooling down the refrigerant by a condenser, wherein an air stream in an air stream circuit is heated up by said condenser,
expanding and cooling down the refrigerant by expansion means,
heating up the refrigerant by an evaporator, wherein the air stream in the air stream circuit is cooled down by said evaporator,
compressing and heating up again the refrigerant by the compressor,
feeding a primary part of the refrigerant coming from the compressor to the condenser,
branching off a secondary part of the refrigerant coming from the compressor to a branch circuit portion,
condensing and cooling down the primary part of the refrigerant by the condenser,
cooling down the secondary part of the refrigerant by an internal heat exchanger, wherein the refrigerant between an outlet of the evaporator and an inlet of the compressor is heated up, and
mixing the primary part and secondary part of the refrigerant before feeding the mixed refrigerant to the evaporator.

12. The method according to claim 11, wherein
the feeding of a secondary part of the refrigerant through the branch circuit portion occurs during a steady working phase of the heat pump system.

13. The method according to claim 11, wherein
the mixing of the primary part and secondary part of the refrigerant occurs before feeding the mixed refrigerant to the expansion means.

14. The method according to claim 11, wherein
the mixing of the primary part and secondary part of the refrigerant occurs after expanding the primary part and secondary part of the refrigerant.

15. The method according to claim 11,
the secondary part of the refrigerant is cooled down and condensed by an auxiliary condenser in the branch circuit portion.

16. The laundry dryer according to claim 2, wherein the control valve is arranged downstream of the high pressure side of the internal heat exchanger.

17. The laundry dryer according to claim 2, wherein the control valve is an adjustable control valve.

18. The laundry dryer according to claim 8, wherein an auxiliary fan is provided for cooling down the auxiliary condenser, and wherein the cooling fan is configured to be activated when the steady state working phase of the heat pump starts.
